(19) United States
(12) Patent Application Publication
(10) Pub. No.: US 2024/0293886 A1
(43) Pub. Date: Sep. 5, 2024

(54) HYBRID WELDER POWERED BY AC AND DC POWER SOURCES

(71) Applicant: MILWAUKEE ELECTRIC TOOL CORPORATION, Brookfield, WI (US)

(72) Inventors: Carl B. Westerby, Menomonee Falls, WI (US); Luke J. Skinner, West Bend, WI (US); Christopher J. Derksen, Hartland, WI (US); Brandon W. Nowicki, Brookfield, WI (US); Ryan J. Denissen, Sussex, WI (US)

(21) Appl. No.: 18/592,827

(22) Filed: Mar. 1, 2024

Related U.S. Application Data
(60) Provisional application No. 63/488,259, filed on Mar. 3, 2023.

(51) Int. Cl. B23K 9/10; H02J 1/06; H02J 7/02

(52) U.S. Cl. CPC B23K 9/1043; H02J 1/06; H02J 7/02

(57) ABSTRACT

Embodiments described herein provide methods and hybrid welder devices including a housing, an alternating current (“AC”) power input, a battery pack interface, a welding circuit, and an electronic controller. The housing including the battery pack interface and the AC power input. The battery pack interface receives a removable battery pack. The AC power input receives power from an AC power source and output an AC power output. The welding circuit provides power to a welding electrode using the AC power input. The electronic controller connected to the AC power source and the removable battery pack. The electronic controller receives power from the AC power source and determines whether the power from the AC power source exceeds a maximum power output threshold. The electronic controller also supplements the power provided to the welding circuit with power from the removable battery pack in response to the power exceeding the maximum output threshold.

### RELATED APPLICATIONS

This application claims priority to, and the benefit of U.S. Provisional Patent Application No. 63/488,259, filed Mar. 3, 2023, the entire contents of which is hereby incorporated by reference.

### SUMMARY

Embodiments described herein provide a hybrid welder including a housing, an alternating current (“AC”) power input, a battery pack interface, a welding circuit, and an electronic controller. The housing including the battery pack interface and the AC power input. The battery pack interface receives a removable battery pack. The AC power input receives power from an AC power source and output an AC power output. The welding circuit provides power to a welding electrode using the AC power input. The electronic controller connected to the AC power source and the removable battery pack. The electronic controller includes an electronic processor and a memory. The electronic controller receives power from the AC power source and determines whether the power from the AC power source exceeds a maximum power output threshold. The electronic controller also supplements the power provided to the welding circuit with power from the removable battery pack in response to the power exceeding the maximum output threshold.

In some aspects, the maximum power output threshold is 92% of a full rated output of the AC power source.

In some aspects, the electronic controller determines whether the removable battery pack has sufficient power to provide the supplemental power to the welding circuit.

In some aspects, the removable battery pack is determined to have sufficient power where a state-of-charge of the removable battery pack is at least 50% of a full state-of-charge.

In some aspects, the removable battery pack has a nominal voltage of 72 VDC.

In some aspects, the removable battery pack is a fan-cooled removable battery pack.

In some aspects, the hybrid welder includes a booster circuit coupled between the battery pack interface and the welding circuit. In those aspects, the booster circuit boosts an output voltage of the removable battery pack to a voltage required by the welding circuit.

In some aspects, the voltage required by the welding circuit is approximately 170 VDC.

Embodiments described herein provide methods for powering a hybrid welding device. The methods include receiving an alternating current (“AC”) power from an AC power source an at a welding circuit. The methods also include determining, at an electronic processor of the hybrid welding device, whether the AC power from the AC power source exceeds a maximum power output threshold. The methods also include supplementing the power provided to the welding circuit with power from a removable battery pack coupled to the welding circuit in response to the power exceeding the maximum output threshold.

In some aspects, the methods further include detecting a loss of AC power at the welding circuit by the electronic processor and supplementing the power provided to the welding circuit with power from a removable battery pack coupled to the welding circuit in response to detecting the loss of AC power.

In some aspects, the maximum power output threshold is 92% of a full rated output of the AC power source.

In some aspects, the methods also include determining, by the electronic processor, whether the removable battery pack has sufficient power to provide the supplemental power to the welding circuit. The methods further include supplementing the power provided to the welding circuit with power from a removable battery pack coupled to the welding circuit in response to the power exceeding the maximum output threshold and determining that the removable battery pack has sufficient power to provide the supplemental power to the welding circuit.

In some aspects, the removable battery pack is determined to have sufficient power where a state-of-charge of the battery removable battery pack is at least 25% of a full state-of-charge.

In some aspects, the removable battery pack is a fan cooled removable battery pack with a nominal output voltage of 72 VDC.

In some aspects, the methods also boosting an output voltage of the removable battery pack to a voltage required by the welding circuit using a booster circuit coupled between the removable battery pack and the welding circuit.

Further embodiments described herein provide a hybrid welder including a housing, an alternating current (“AC”) power input, a battery pack interface, a welding circuit, a power control circuit, and an electronic controller. The housing including the battery pack interface and the AC power input. The battery pack interface receives a removable battery pack. The AC power input receives power from an AC power source and output an AC power output. The welding circuit provides power to a welding electrode using the AC power input. The power control circuit charges the removable battery pack using the received AC power. The electronic controller connected to the AC power source and the removable battery pack. The electronic controller includes an electronic processor and a memory. The electronic controller receives power from the AC power source and determines whether the power from the AC power source exceeds a maximum power output threshold. The electronic controller also determines whether the removable battery pack has sufficient power to provide a supplemental power to the welding circuit. The electronic controller also supplements the power provided to the welding circuit with power from the removable battery pack in response to the power exceeding the maximum output threshold and the removable battery pack being determined to have sufficient power to provide the supplemental power to the welding circuit.

In some aspects, the maximum power output threshold is 92% of a full rated output of the AC power source.

In some aspects, the removable battery pack is determined to have sufficient power where a state-of-charge of the removable battery pack is at least 25% of a full state-of-charge.

In some aspects, the hybrid welding device includes a booster circuit coupled between the battery pack interface and the welding circuit. In those aspects, the booster circuit boosts an output voltage of the removable battery pack to a voltage required by the welding circuit.

In some aspects, the voltage required by the welding circuit is approximately 170 VDC.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a hybrid welder, according to some embodiments described herein.

FIGS. 2A and 2B illustrates different sizes of battery packs for powering the hybrid welder of FIG. 1, according to some embodiments described herein.

FIG. 3 illustrates an adapter including an AC/DC adapter assembly with a power box, according to some embodiments described herein.

FIG. 4A illustrates a controller for the hybrid welder of FIG. 1, according to some embodiments described herein.

FIG. 4B illustrates a communication controller for the hybrid welder of FIG. 1, according to some embodiments described herein.

FIG. 4C illustrates a communication system for the hybrid welder of FIG. 1, according to some embodiments described herein.

FIG. 5 illustrates a configuration of a hybrid welder that is powered by both AC and DC input power sources, according to some embodiments described herein.

FIG. 6 illustrates a configuration of a hybrid welder that is powered by both AC and DC input power sources, according to some embodiments described herein.

FIG. 7A illustrates a configuration of a hybrid welder operable in a hybrid power mode, according to some embodiments described herein.

FIG. 7B illustrates an example schematic configuration of a hybrid welder operable in a hybrid power mode, according to some embodiments described herein.

FIG. 8 illustrates a process for controlling the hybrid welder of FIG. 1, according to some embodiments described herein.

FIG. 9 illustrates a process for controlling the hybrid welder of FIG. 1, according to some embodiments described herein.

FIG. 10 illustrates a process for controlling the hybrid welder of FIG. 1 with respect to a loss of primary power, according to some embodiments described herein.

### DETAILED DESCRIPTION

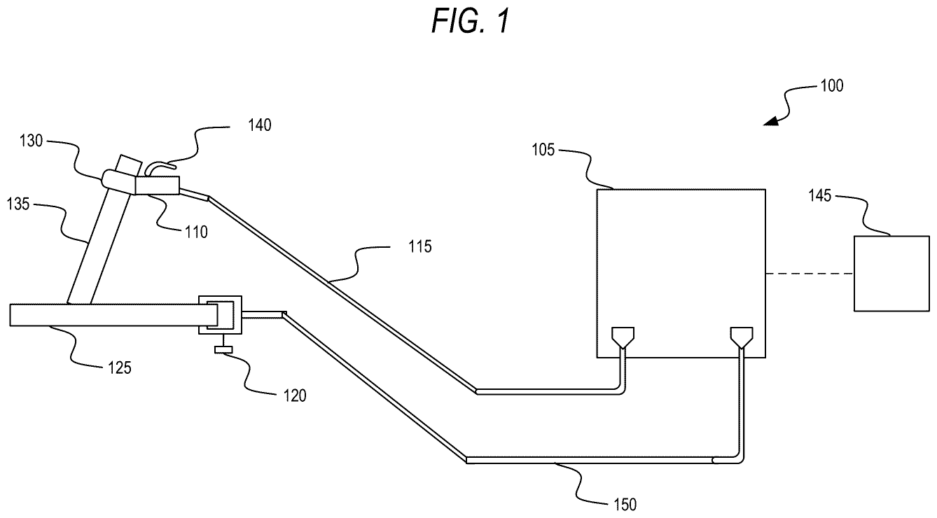

FIG. 1 illustrates a hybrid welder 100. The hybrid welder 100 may be a metal flux-cored arc welder, a tungsten inert gas (“TIG”) welder, a metal inert gas (“MIG”) welder, or other welder as required for a given application. The welder 100 includes a housing 105, which may be configured as a backpack and/or include one or more handles to facilitate transport by a user while performing welding operations. The welder 100 also includes an electrode holder 110 connected to the housing 105 by an electrode cable 115, and an electrically conductive ground cable 150 with an associated ground clamp 120 that is connectable to a metal workpiece 125. The electrode holder 110 includes a mount 130 to which a consumable electrode 135 is attached and a user input 140 (e.g., a switch, a button, a trigger, etc.) operable to activate the welder 100 and perform a welding operation on the workpiece.

The welder 100 also includes at least one removable and rechargeable battery pack 145 that is detachably coupled to the housing 105. In the illustrated embodiment, the battery pack 145 is configured as a rechargeable lithium-based power tool battery pack to provide a source of DC power for directing a current through the electrode cable 115, the electrode holder 110, the electrode 135, the workpiece 125, the ground clamp 120, and/or the ground cable 150 during a welding operation. In particular, the battery pack 145 has a nominal voltage of up to about 30-240 volts (V) and is operated to output high power (e.g., power of 2760 watts [W] to 3000 W or more [3.7 horsepower (hp) to 4.0 hp or more]) for sustained durations (e.g., at least 5-6 minutes or more). In some embodiments, the nominal voltage of the battery pack 145 is 72V DC. However, nominal voltages of more than 72 VDC or less than 72 VDC are also contemplated as required for a given application. The battery pack 145 may be configured to output a high sustained current (e.g., 50 amps [A] or more) in some embodiments. However, output currents of more than 50 amps or less than 50 amps are also contemplated. Such a battery pack 145 is described in further detail in U.S. patent application Ser. No. 16/025,491, filed Jul. 2, 2018, the entire content of which is incorporated herein by reference. In some examples, the battery pack 145 may include a fan or other active heat dissipation features (e.g., cooling) to allow for constant current output to be available without overheating the battery pack 145. In one example, the battery pack 145 may be an MX FUEL™ battery pack from Milwaukee Tool.

In some embodiments, the welder 100 is also powered by an alternating current (“AC”) power source such that the welder 100 is configured to simultaneously receive power from both an AC power source and a DC power source (e.g., the battery pack 145) as will be described in more detail below.

In some embodiments, rather than using a fixed length consumable electrode 135, the welder 100 may include a wire feed mechanism supported by the housing 105 for feeding a consumable welding wire through the electrode cable 115 to be dispensed from a welding tip of the electrode holder (which in this embodiment would be considered as a welding gun). In such an embodiment, the consumable welding wire may require an inert gas to be applied near the welding tip during a welding process as is common in metal/inert gas (MIG) welding. In this embodiment, the welder 100 may further include a provision for attachment to a gas source for directing an inert gas through the welding tip. The gas source may be a gas tank coupled to the housing via a feed line.

In some embodiments, the housing may have one or more features that allow for connection to an equipment packaging system, such as the PACKOUT® system from Milwaukee Tool.

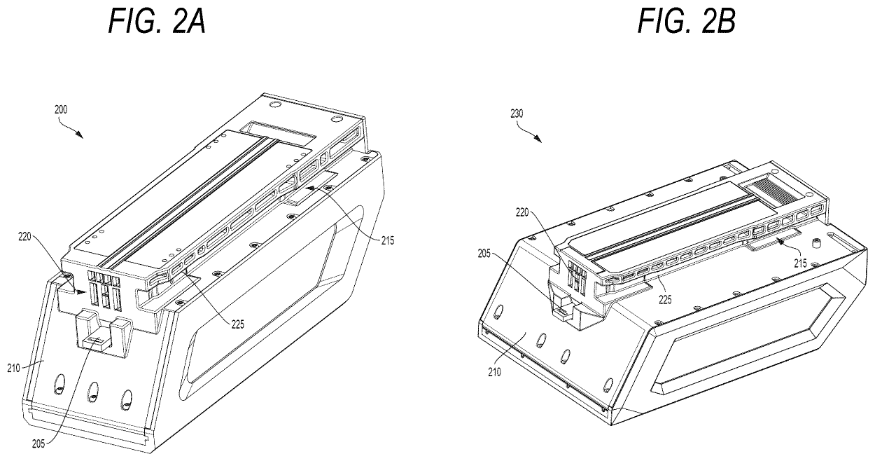

FIG. 2A illustrates a battery pack 200 that is detachable to the housing 105. The battery pack may include one or more cell strings, each having a number (e.g., 10) of battery cells connected in series to provide a desired discharge output (e.g., nominal voltage [e.g., 20 V, 40 V, 60 V, 80 V, 120 V] and current capacity). Accordingly, the battery pack 200 may include “20S1P,” “20S2P,” etc., configuration. In other embodiments, other combinations of battery cells are also possible.

Each battery cell may have a nominal voltage between 3 V and 5 V and may have a nominal capacity between 3 Ampere-hours (Ah) and 10 Ah. Each battery cell has a diameter of up to about 21 mm and a length of up to about 71 mm. The battery cells may be any rechargeable battery cell chemistry type, such as, for example, lithium (Li), lithium-ion (Li-ion), other lithium-based chemistry, nickel-cadmium (NiCd), nickel-metal hydride (NiMH), etc.

With reference to FIG. 2A, the hybrid welder 100 may be configured to operate using various battery sizes and power sources, some of which are described below. In some embodiments, the hybrid welder uses a 216 Watt-hour (“Wh”) battery pack. In other embodiments, the hybrid welder uses a 420 Wh battery pack. In yet another embodiment, the hybrid welder uses a 630 Wh battery pack or a 1000 Wh battery pack. In some embodiments, the battery pack is between about a 200 Wh battery pack and a 1000 Wh battery pack. In other embodiments, the hybrid welder 100 is compatible with a wall adapter. The wall adapter fits into a battery location located on the hybrid welder 100, then may be plugged into the wall to allow the hybrid welder 100 to be run off of AC power from an AC/DC power adapter integrated with the wall adapter.

In some embodiments, the hybrid welder 100 uses a battery pack having a power rating below 200 Wh. For example, a 27 Wh battery pack (e.g., 18V nominal voltage and a 1.5 Ah capacity) can be used to power the hybrid welder 100. In some embodiments, a 90 Wh battery pack (e.g., 18V nominal voltage and a 5 Ah capacity) can be used to power the hybrid welder 100. In some embodiments, a battery pack between 25 Wh and 270 Wh can be used to power the hybrid welder 100. In some embodiments, a plurality of battery packs are used to power the hybrid welder 100. For example, two to four battery packs (e.g., 18V nominal voltage and capacities between 1.5 Ah and 15 Ah) can be connected in series or parallel to provide between, for example, 27 Wh and 1080 Wh of power to the hybrid welder 100.

A battery pack 200 having a 20S1P configuration is illustrated in FIG. 2A in accordance with some embodiments. The battery pack 200 includes a battery pack housing 210 with a support portion 215 and a battery terminal block 220. The battery pack housing 210 encloses components of the battery pack 200 including the battery cells, a battery controller, etc. The support portion 215 provides a slide-on arrangement with a projection/recess 225 cooperating with a complementary projection/recess 225 of the combination.

The battery pack 200 defines a length within a range of approximately 260 mm to approximately 280 mm. In some embodiments, the length is approximately 270 mm. In some embodiments, the length is approximately 270 mm. The battery pack 200 defines a width of the battery pack 200 within a range of approximately 90 mm to approximately 110 mm. In some embodiments, the width is approximately 100 mm. The battery pack 200 defines a height of the battery pack 200 with a range of 96 mm to approximately 116 mm. In some embodiments, the height of the battery pack 200 is approximately 106 mm. The total weight of the battery pack 200 is within a range of approximately 5.5 lbs. to 6.5 lbs. In some embodiments, the total weight of the battery pack 200 is approximately 6 lbs.

The battery pack 200 has an AC internal resistance (ACIR) within a range of approximately 150 mΩ to approximately 160 mΩ. The battery pack 200 has a DC internal resistance within a range of approximately 220 mΩ to approximately 260 mΩ.

FIG. 2B illustrates another embodiment of a battery pack 230 that is detachable to the housing 105. The battery pack 230 having a 20S2P configuration is illustrated in accordance with some embodiments. The battery pack 230 includes two cell strings of twenty series connected cells, the cell strings being connected in parallel. The battery pack 230 defines a length within a range of approximately 260 mm to approximately 280 mm. In some embodiments, the length of the battery pack 230 is approximately 270 mm. The battery pack defines a width within a range of approximately 171 mm to approximately 191 mm. In some embodiments, the width of the battery pack 230 is approximately 181 mm. The battery pack 230 defines a height within a range of approximately 96 mm to approximately 116 mm. In some embodiments, the height of the battery pack 230 is approximately 106 mm. The total weight of the battery pack 230 is within a range of approximately 10.25 lbs. to 11.25 lbs. In some embodiments, the total weight of the battery pack 230 is approximately 10.75 lbs. In some embodiments a 20S3P battery pack is detachable to the housing 105.

The battery pack 230 has an AC internal resistance (ACIR) within a range of approximately 75 mΩ to approximately 80 mΩ. The battery pack 230 has a DC internal resistance within a range of approximately 130 mΩ to approximately 170 mΩ.

The battery packs 200, 230 of FIG. 2A and FIG. 2B include a switch 205 extending from the housing 210. The switch 205 is configured to be in a first position and a second position. When in the first (e.g., “OFF”) position, electrical components (for example, the subcores) of the battery packs 200, 230 contained within the housing 210 are electrically disconnected from each other. When in the second (e.g., “ON”) position, electrical components (e.g., battery cell subcores) are electrically connected to each other. The switch 205 may be manipulated by a user from the first position to a second position by pressing or sliding the switch 205.

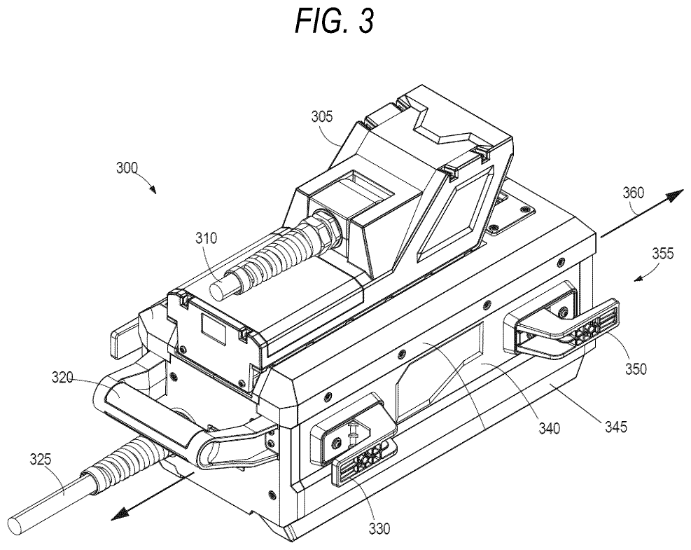

The hybrid welder 100 may also be configured to receive a power adapter 305 as shown in FIG. 3. The power adapter 305 is an AC/DC adapter assembly 300 including a power box 340 is operable to receive an input alternating current (AC) power via a power cord and supply direct current (DC) power via an adapter 305 to the hybrid welder 100. Accordingly, the welder 100 can be powered from two separate AC power inputs (e.g., a direct AC input power source and a second AC input that uses the power adapter 305 to convert AC power to DC power). In some embodiments, the two AC power inputs are provided by the same AC power source. In other embodiments, the two AC power inputs are provided by different AC power sources (e.g., AC mains power and AC power from a power supply). An adapter cord 310 electrically connects the adapter 305 to a power box 340. In other constructions, the power assembly 300 may receive power from another power source (e.g., a DC power source [a battery pack], a generator, etc.).

The power box 340 includes a housing 345 formed, in the illustrated construction, of two clamshell housing halves connected along plane 360. The in illustrated construction, the housing halves are connected with threaded fasteners (e.g., screws) or other suitable coupling means. Together, the housing halves define an internal compartment within the housing 345 containing internal components of the power box 340.

The housing 345 includes a handle 320 formed at a first end opposite a second end and a storage portion operable to selectively receive the power adapter 305 for convenient storage when the power adapter 305 is not in use. In additional or alternative embodiments, the storage portion may be configured to receive the pack engagement portion to selectively couple the battery pack to the power box 340. The storage portion is formed in a first or top side of the power box 340. The storage portion includes a recessed cavity open at an open end proximate the first end and adjacent the handle 320 and closed at a closed end.

The illustrated power box 340 includes a cord wrap arrangement operable to selectively receive a wound cord (e.g., the power cord 325 and/or the adapter cord 310) for compact and convenient storage when the power adapter 305 is not in use. In the illustrated construction, a pair of cord wraps are provided on opposite sides of the housing 345. In the illustrated construction, each cord wrap 355 includes a pair of longitudinally opposed hooks 330, 350 projecting laterally outwardly from the housing 345. That is, in the illustrated construction, a first cord wrap is configured to receive the power cord in a wound configuration. In other constructions, the power box 340 may include a single cord wrap 355 (large enough to receive the provided cords [e.g., the power cord and the adapter cord 310]) or more than two cord wraps 355.

The power adapter cord 310 has a length (e.g., at least about 2 meters [m]) and a diameter (e.g., about 10 mm to about 13 mm). In the illustrated construction, the cord length allows a user to operate the portable adapter 305 at or near an eye level while the power box 340 is resting at or near ground level, which limits excess adapter cord 310 that can be cumbersome during use. In other constructions, the cord length can be less than or greater than 3 meters so as to be adapted to particular uses of the portable adapter 305.

The power box 340 has at least one foot that projects downwardly from the housing 345 and that is engageable with a support surface. In the illustrated construction, the power box 340 has a pair of longitudinally extending feet at opposite sides of the housing 345. In particular, each of the feet is coupled to a second or bottom side of the housing 345 and has a first surface that is substantially perpendicular to the second side of the power box 340 and a second surface that is oriented at an angle α relative to the second side of the power box 340. Each of the feet has a polygonal cross-section. In other or additional constructions, the power box may have four separate feet positioned proximate the corners. In still other constructions, the power box 340 have feet having any suitable location and configuration. The feet provide the power box 340 with a stable and robust resting surface when the power box 340 is supported on the floor or the ground. For example, the feet allow the power box 340 to straddle obstacles or otherwise address uneven ground surfaces. The feet also raise the housing 345 to a certain height above the ground, thereby preventing or inhibiting contaminants (e.g., pooled liquids, dust, other debris, etc.) from entering the housing 345 and interfering with the internal components of the power box 340. In the illustrated construction, the height is approximately 30 mm, but may range from 20 mm to 40 mm.

The power adapter 300 includes a circuit operable, in the illustrated construction, to receive AC power as an input and to output DC power. The circuit includes the necessary electrical components to operate as an AC/DC adapter (e.g., a rectifier). The circuit may include other components (e.g., a battery charging circuit portion to charge a connected battery pack, a pass-through circuit portion to output AC power to an AC outlet, an output circuit portion to output DC power to a DC power outlet, etc.). The circuit further includes a Ground Fault Circuit Interrupt (GFCI) protection system to protect against electrical shock during operation. GFCI controls are located on the housing 345 adjacent the storage portion.

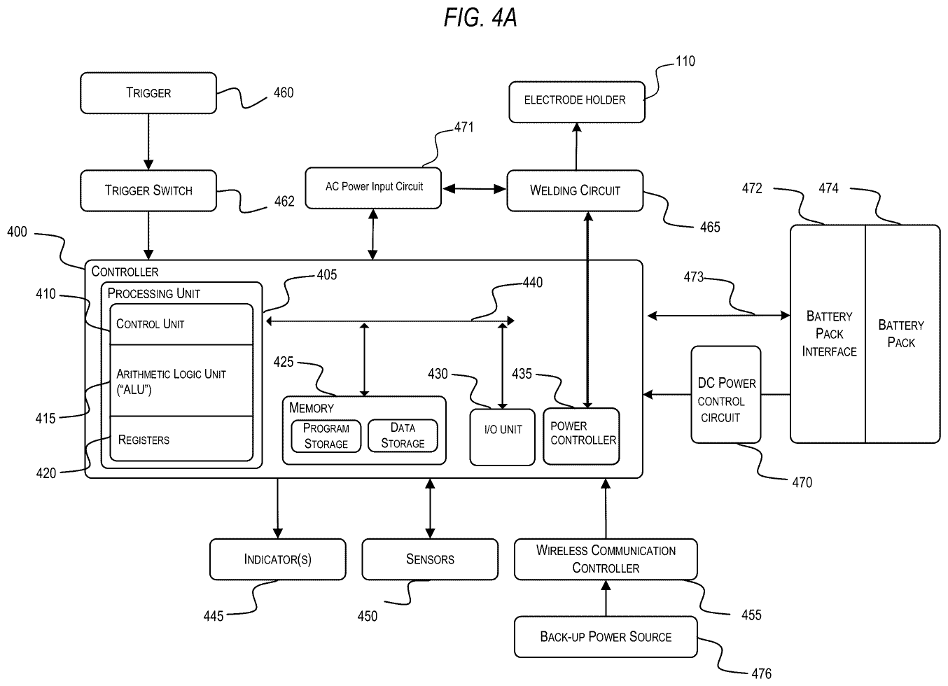

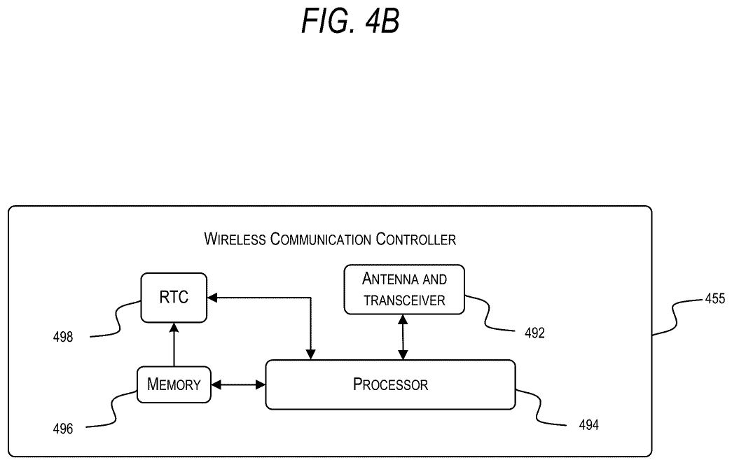

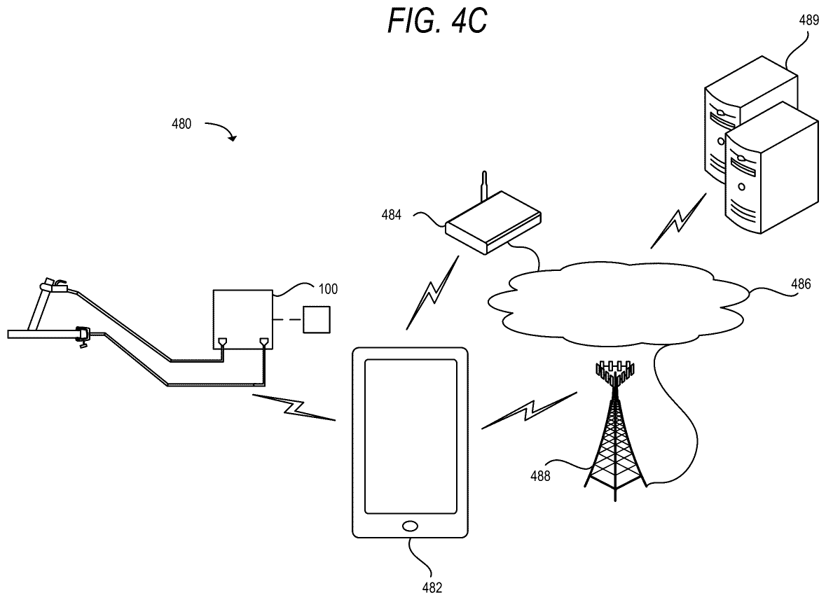

FIG. 4A illustrates a controller 400 for the hybrid welder 100. The controller 400 is electrically and/or communicatively connected to a variety of modules or components of the hybrid welder 100. For example, the illustrated controller 400 is connected to indicators 445, sensors 450 (which may include, for example, a pressure sensor, a current sensor, a voltage sensor, a position sensor, etc.), a wireless communication controller 455, a trigger 460, a trigger switch 462, a welding circuit 465, a DC power control unit 470, and an AC power input circuit 471.

The controller 400 includes a plurality of electrical and electronic components that provide power, operational control, and protection to the components and modules within the controller 400 and/or hybrid welder 100. For example, the controller 400 includes, among other things, a processing unit 405 (e.g., a microprocessor, an electronic processor, an electronic controller, a microcontroller, or another suitable programmable device), a memory 425, an input/output (“I/O”) unit 430, and a power controller 435. The processing unit 405 includes, among other things, a control unit 410, an arithmetic logic unit (“ALU”) 415, and a plurality of registers 420 (shown as a group of registers in FIG. 4A) and is implemented using a known computer architecture (e.g., a modified Harvard architecture, a von Neumann architecture, etc.). The processing unit 405, the memory 425, the I/O 430, and the power controller 435, as well as the various modules or circuits connected to the controller 400 are connected by one or more control and/or data buses (e.g., common bus 440). The control and/or data buses are shown generally in FIG. 4A for illustrative purposes. The use of one or more control and/or data buses for the interconnection between and communication among the various modules and components would be known to a person skilled in the art in view of the embodiments described herein.

The memory 425 is a non-transitory computer readable medium and includes, for example, a program storage area and data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 405 is connected to the memory 425 and executes software instruction that are capable of being stored in a RAM of the memory 425 (e.g., during execution), a ROM of the memory 425 (e.g., on a generally permanent basis), or another non-transitory computer readable medium such as another memory or a disc. Software included in the implementation of the hybrid welder 100 can be stored in the memory 425 of the controller 400. The software includes, for example, firmware, one or more applications, program data, filters, rules, one or more program modules, and other executable instructions. The controller 400 is configured to retrieve from the memory 425 and execute, among other things, instructions related to the control processes and methods described herein. In other embodiments, the controller 400 includes additional, fewer, or different components.

The DC power control unit 470 may interface with a battery pack interface 472, which in turn is coupled to a battery pack 474. In some examples, the battery pack 474 may be similar to the battery packs, such as battery packs 200, 230, described above. In some examples, the battery pack interface 472 may be configured to receive the power adapter 300, described above. In some embodiments, the battery pack interface 472 may provide data to the controller 400 via the DC power control unit 470. In other embodiments, the battery pack interface 472 may provide battery pack data to the controller via the communication line 473. Example battery pack data may include battery pack voltage, state-of-health, state-of-charge, temperature, and/or other battery pack parameters as required for a given application.

In one embodiment, the controller 400 is configured to control the welding circuit 465 to perform welding tasks in response to a user's actuation of the trigger 460. Depression of the activation trigger 460 actuates a trigger switch 462, which outputs a signal to the controller 400 to activate the welding circuit 465, which in turn may provide the necessary power to the electrode holder 110 to perform a welding operation. The controller 400 controls the power received from a battery pack 474 to maintain a constant welding power, via the power controller 435. In some embodiments, the controller 400 controls the power received from the AC power input circuit 471 and/or the battery pack 474 to maintain a constant welding power via the power controller 435. In some embodiments, the hybrid welder 100 includes a voltage converter (e.g., a DC-to-DC converter, a synchronous buck converter, an asynchronous buck converter, voltage regulators, etc.). In those embodiments, the controller 400 controls the voltage converter to step down a voltage from the AC power input circuit 471 and/or the battery pack 474 because the battery pack has a voltage that is greater than the voltage required by the welding circuit 465. The voltage converter and the AC power input circuit 471 and/or the battery pack 474 provide a constant voltage source for the hybrid welder 100 and provide power to the welding circuit 465 via the power controller 435.

In response to the trigger 460 being released, the trigger switch 462 no longer outputs the actuation signal (or outputs a released signal) to the controller 400. The controller 400 may control the welding circuit 465 to cease a welding operation when the trigger 460 is released by controlling the welding circuit 465 to turn off the welding circuit 465.

As described above, a battery pack interface 472 is connected to the controller 400 and couples the controller 400 to a battery pack 474 that is removably coupleable to the battery pack interface 472. The battery pack interface 472 includes a combination of mechanical (e.g., a battery pack receiving portion) and electrical components configured to and operable for interfacing (e.g., mechanically, electrically, and/or communicatively connecting) the hybrid welder 100 with the battery pack 474. The battery pack interface 472 is coupled to the DC power control unit 470. The battery pack interface 472 transmits the power received from the battery pack 474 to the DC power control unit 470. The DC power control unit 470 includes active and/or passive components (e.g., voltage step-down controllers, voltage converters, rectifiers, filters, etc.) to regulate or control the power received through the battery pack interface 472. When the battery pack 474 is not coupled to the hybrid welder 100, the wireless communication controller 455 is configured to receive power from a back-up power source 476.

The indicators 445 are also coupled to the controller 400 and receive control signals from the controller 400 to turn on and off or otherwise convey information based on different states of the hybrid welder 100. The indicators 445 include, for example, one or more light-emitting diodes (LEDs), or a display screen. The indicators 445 can be configured to display conditions of, or information associated with, the hybrid welder 100. For example, the indicators 445 can display information relating to a welding action performed by the hybrid welder 100. In addition to or in place of visual indicators, the indicators 445 may also include a speaker or a tactile feedback mechanism to convey information to a user through audible or tactile outputs.

FIG. 4B illustrates a wireless communication controller 455 for the hybrid welder 100. The wireless communication controller 455 includes a processor 494, a memory 496, an antenna and transceiver 492, and a real-time clock (RTC) 498. The wireless communication controller 455 enables the hybrid welder 100 to communicate with an external device 482 (see, e.g., FIG. 4C). The radio antenna and transceiver 492 operate together to send and receive wireless messages to and from the external device 482 and the processor 494. The memory 496 can store instructions to be implemented by the processor 494 and/or may store data related to communications between the hybrid welder 100 and the external device 482, or the like. The processor 494 for the wireless communication controller 455 controls wireless communications between the hybrid welder 100 and the external device 482. For example, the processor 494 associated with the wireless communication controller 455 buffers incoming and/or outgoing data communicates with the controller 400 and determines the communication protocol and/or settings to use in wireless communications. The communication via the wireless communication controller 455 can be encrypted to protect the data exchanged between the hybrid welder 100 and the external device 482 from third parties.

In the illustrated embodiment, the wireless communication controller 455 is a Bluetooth® controller. The Bluetooth® controller communicates with the external device 482 employing the Bluetooth® protocol. Therefore, in the illustrated embodiment, the external device 482 and the hybrid welder 100 are within a communication range (i.e., in proximity) of each other while they exchange data. In other embodiments, the wireless communication controller 455 communicates using other protocols (e.g., Wi-Fi, ZigBee, a proprietary protocol, etc.) over different types of wireless networks. For example, the wireless communication controller 455 may be configured to communicate via Wi-Fi through a wide area network such as the Internet or a local area network, or to communicate through a piconet (e.g., using infrared or NFC communications).

In some embodiments, the network is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, 4GSM network, a 4G LTE network, 5G New Radio, a Digital AMPS (“IS-136/TDMA”) network, or an Integrated Digital Enhanced Network (“iDEN”) network, etc.

The wireless communication controller 455 is configured to receive data from the controller 400 and relay the information to the external device 482 via the antenna and transceiver 492. In a similar manner, the wireless communication controller 455 is configured to receive information (e.g., configuration and programming information) from the external device 482 via the antenna and transceiver 492 and relay the information to the controller 400.

The RTC 498 increments and keeps time independently of the other power tool components. The RTC 498 receives power from the battery pack when the battery pack is connected to the hybrid welder 100 and receives power from the back-up power source 476 when the battery pack is not connected to the hybrid welder 100. Having the RTC 498 as an independently powered clock enables time stamping of operational data (stored in memory 496 for later export) and a security feature whereby a lockout time is set by a user (e.g., via the external device 482) and the tool is locked-out when the time of the RTC 498 exceeds the set lockout time.

FIG. 4C illustrates a communication system 480. The communication system 480 includes at least one hybrid welder 100 and the external device 482. Each hybrid welder 100 and the external device 482 can communicate wirelessly while they are within a communication range of each other. Each hybrid welder 100 may communicate hybrid welder 100 status, hybrid welder 100 operation statistics, hybrid welder 100 identification, hybrid welder 100 sensor data, stored hybrid welder 100 usage information, hybrid welder 100 maintenance data, and the like.

More specifically, the hybrid welder 100 can monitor, log, and/or communicate various tool parameters that can be used for confirmation of correct tool performance, detection of a malfunctioning tool, and determination of a need or desire for service. Taking, for example, the hybrid welder parameters are detected, determined, and/or captured by the controller 400 and output to the external device 482 can include a welding time (e.g., time it takes for the hybrid welder to perform a welding task), a time (e.g., a number of seconds) that the hybrid welder 100 is on, a number of overloads, a total number of cycles performed by the tool, a number of cycles performed by the tool since a reset and/or since a last data export, a number of remaining service cycles (i.e., a number of cycles before the tool should be serviced, recalibrated, repaired, or replaced), a number for transmissions sent to the external device 482, a number of transmission sent to the external device 482, a number of errors generated in the transmissions sent to the external device 482, a code violation resulting in a master control unit (MCU) reset, a short in the power circuitry (e.g., a metal-oxide-semiconductor field-effect transistor [MOSFET] short), a non-maskable interrupt (NMI) hardware MCU Reset (e.g., of the controller 400), an over-discharge condition of the battery pack, an overcurrent condition of the battery pack, a battery dead condition at trigger pull, a tool FETing condition, thermal and stall overload condition at trigger pulled at tool sleep condition, heat sink temperature histogram data, MOSFET junction temperature histogram data (from the current sensor), etc.

Using the external device 482, a user can access the tool parameters for the hybrid welder 100. With the tool parameters (i.e., tool operational data), a user can determine how the tool has been used (e.g., number of tasks performed), whether maintenance is recommended or has been performed in the past and identify malfunctioning components or other reasons for certain performance issues. The external device 482 can also transmit data to the hybrid welder 100 for tool configuration, firmware updates, or to send commands. The external device 482 also allows a user to set operational parameters, safety parameters, select tool modes, and the like for the hybrid welder 100.

The external device 482 is, for example, a smart phone (as illustrated), a laptop computer, a tablet computer, a personal digital assistant (PDA), or another electronic device capable of communication wirelessly with the hybrid welder 100 and providing a user interface. The external device 482 provides the user interface and allows a user to access and interact with the hybrid welder. The external device 482 can receive user inputs to determine operational parameters, enable or disable features, and the like. The user interface of the external device 482 provides an easy-to-use interface for the user to control and customize operation of the hybrid welder. The external device 482, therefore, grants the user access to the tool operational data of the hybrid welder, and provides a user interface such that the user can interact with the controller 400 of the hybrid welder 100.

In addition, as shown in FIG. 4C, the external device 482 can also share tool operational data obtained from the hybrid welder 100 with a remote server 489 connected through a network 486. The remote server 489 may be used to store the tool operational data obtained from the external device 482, provide additional functionality and service to the user, or a combination thereof. In some embodiments, storing the information on the remote server 489 allows a user to access the information from a plurality of different locations. In some embodiments, the remote server 489 collects information from various users regarding their power tool devices and provide statistics or statistical measures to the user based on information obtained from the different tools. For example, the remote server 489 may provide statistics regarding the experienced efficiency of the hybrid welder 100, typical usage of the hybrid welder 100, and other relevant characteristics and/or measures of the hybrid welder 100. The network 486 may include various networking elements (routers 484, hubs, switches, cellular towers 488, wired connections, wireless connections, etc.) for connecting to, for example, the Internet, a cellular data network, a local network, or a combination thereof as previously described. In some embodiments, the hybrid welder 100 is configured to communicate directly with the server 489 through an additional wireless interface or with the same wireless interface that the hybrid welder uses to communicate with the external device 482.

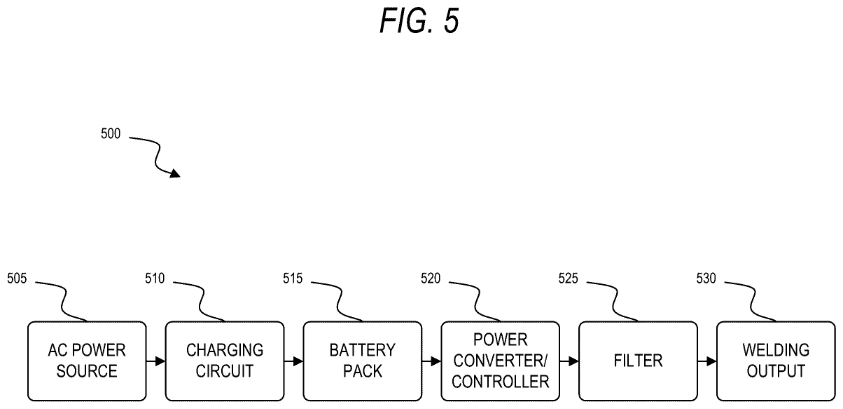

FIG. 5 illustrates a simplified block diagram of a welder 500. The welder 500 can include all of the components and features of the welder described above with respect to the hybrid welder 100, and common terms should be understood to be interchangeable. FIG. 5 specifically illustrates an input power flow configuration for the welder 500. Specifically, the welder 500 receives input power from an AC power source 505. The AC power source 505 is configured to provide power to a charging circuit 510. The charging circuit 510 is configured to charge a battery pack 515 that is separately connectable from the AC power source 505 to the welder 500. The battery pack 515 then provides output power for powering a power converter and/or controller 520 for powering the welder 500. In some embodiments, the welder 500 includes an optional filtering stage or circuit 525 before ultimately powering the welding output 530.

Among the advantages of a welder that can be powered from both an AC power source 505 and a DC power source, such as battery pack 515, is that the welder 500 is not constrained in the way that a conventional welder would be constrained. For example, conventional welders are AC powered and are limited in power output to, for example, 120V AC and/or 240V AC. Greater power levels than the AC power source can provide may result in, for example, a circuit breaker of an electrical system tripping or another fault condition occurring. By also including a DC power source, the DC power source can be used to supplement the AC power source to provide higher power levels to the welder 500 than would otherwise be achievable. Such a dual source configuration also has the benefit of extending run time of the welder 500 over a welder that was, for example, only powered by the battery pack 515.

In some embodiments, the charging circuit 510 continuously charges the battery pack 515 when the welder 500 is either idle (e.g., not producing the welding output 530) or when welding (e.g., producing the welding output 530). In other embodiments, the charging circuit 510 is only active for charging the battery pack 515 when the welder 500 is idle. For example, the welder 500 may become idle due to a user's workflow (e.g., inactive for a predetermined period of time), or the welder 500 may become idle based on a command from a controller due to a fault condition (e.g., over temperature condition).

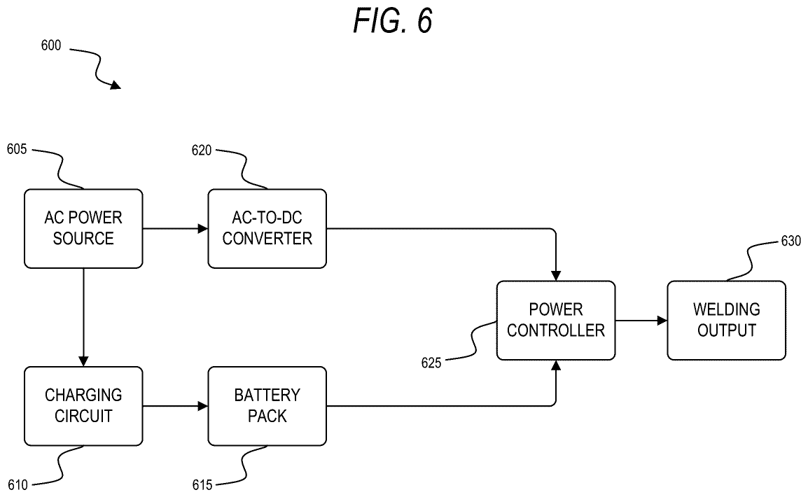

FIG. 6 illustrates a simplified block diagram of a welder 600. The welder 600 may include all of the components and features of the welder described above with respect to the welder 100, and the common components should be understood to be used interchangeably herein. FIG. 6 specifically illustrates an input power flow configuration for the welder 600. Specifically, the welder 600 receives input power from an AC power source 605. The AC power source 605 is configured to provide power to a charging circuit 610. The charging circuit 610 is configured to charge a battery pack 615 that is separately connectable from the AC power source 605 to the welder 600. The AC power source 605 also provides power to an AC-to-DC converter 620. The AC-to-DC converter 620 converts the input AC power from the AC power source to DC power that can be used to power the output of the welder 600. For example, the output DC power from the AC-to-DC converter 620 is provided to a power controller 625 that powers a welding output 630. The battery pack 615 is also configured to provide output power for powering the power controller 625 to power the welding output 630. The various components in FIG. 6 may be controlled by a controller, such as controller 400 described above.

In some embodiments, the welder 600 is configured to use the AC power source 605 as a primary power source for powering the welding output 630. The welder 600 will use the AC power source as the primary power source up to a predefined power threshold (e.g., a maximum power level than can be supplied by the AC power source). In response to the predefined power threshold being reached, the controller 400 may control the power controller welder 600 may draw power from the battery pack 615. In some embodiments, the predefined power threshold may be automatically determined based on the voltage of the AC input. In other examples, the predefined power threshold may be based on other parameters, such as rating of a circuit breaker associated with the AC input, a user input, and/or other parameters as required for a given application.

In some embodiments, the charging circuit 610 continuously charges the battery pack 615 when the welder 600 is drawing power from the battery pack 615 (e.g., when supplementing the AC power source 605) and when power is not being drawn from the battery pack 615 (e.g., the predefined power threshold has not been met). In other embodiments, the charging circuit 610 is only active when power from the battery pack 615 is not being drawn (e.g., the predefined power threshold has not been met). For example, the welder 600 may become idle due to a user's workflow (e.g., inactive for a predetermined period of time), or the welder 600 may become idle based on a command from a controller due to a fault condition (e.g., over temperature condition).

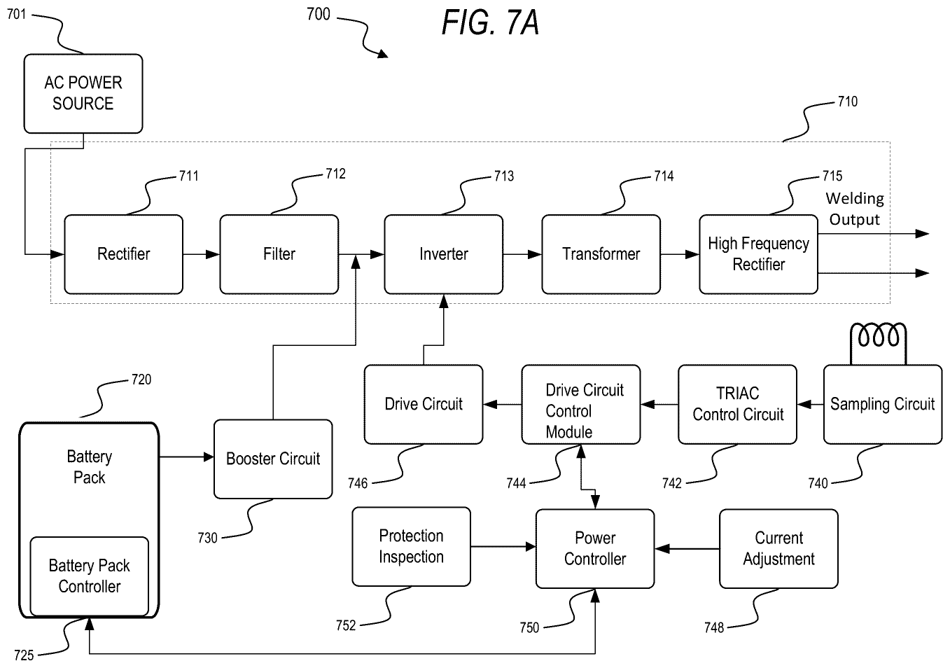

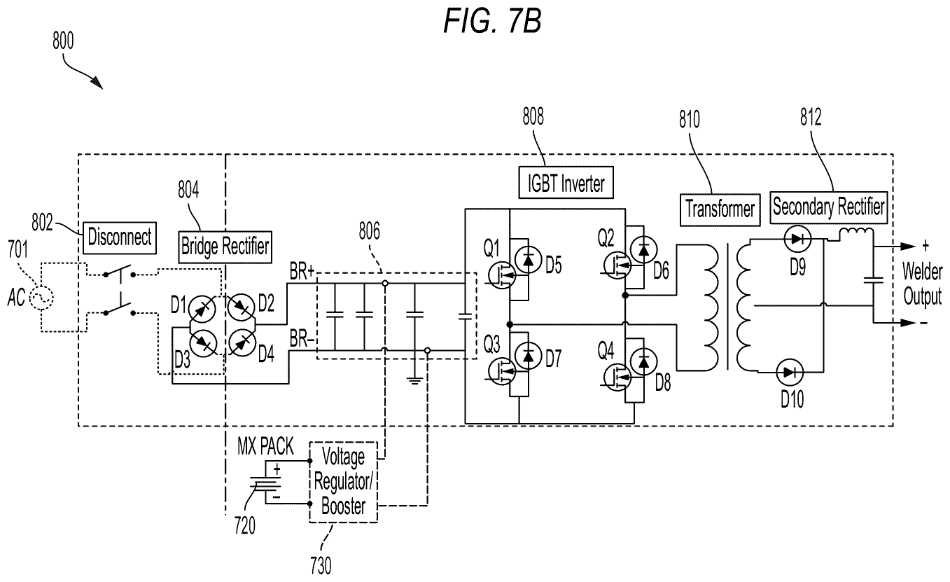

FIG. 7A illustrates a simplified block diagram of a welder 700. Welder 700 may be similar to welders 100, 500, 600 described above. The welder 700 can include all of the components and features of the described above with respect to the welder 100, in addition to the components described below. FIG. 7A illustrates power regulation circuitry for the welder 700. The welder 700 receives input power from an AC power source 701.

The AC power source 701 is configured to provide power to a welding circuit 710. In some examples, the welding circuit 710 may be similar to the welding circuit 465 described above. The welding circuit 710 is configured to convert the input AC power from the AC power source 701 to DC power that can be used to power the output of the welder 700. The welding circuit 710 includes a rectifier 711, a filter 712, an inverter 713, a transformer 714, and a high frequency rectifier 715. The rectifier 711 is configured to convert the AC voltage from the AC power source 701 to a DC voltage. In one embodiment, the rectifier 711 may be a bridge rectifier; however other rectifier designs are also considered as required for a given application.

The filter 712 is configured to reduce ripples in the DC voltage received from the rectifier 711. For example, the filter 712 may include one or more capacitors configured to reduce the AC ripple output form the rectifier 711 to provide a constant DC voltage. In one embodiment, the constant DC voltage may be approximately 170 VDC. However, voltages greater than 170 VDC and less than 170 VDC are also contemplated. The inverter 713 is configured to convert the DC voltage received from the rectifier 711 to AC voltage.

In some instances, the inverter 713 may further be configured to convert DC voltage received from a battery pack 720 via a booster circuit 730. As described in more detail below, the booster circuit 730 may be configured to increase the voltage of the battery pack 720 to be approximately the same as the voltage level output from the filter 712. The booster circuit 730 may be configured as a boost and/or step-up circuit as known in the art. In other examples, the booster circuit 730 may be a buck/boost circuit to allow for a range of battery pack voltages, both above and below the voltage level output from the filter 712. In one example, the booster circuit 730 may be similar to the power controller 435 described above. In one example, the booster circuit 730 may be configured to increase the voltage of the battery pack 720 to approximately 170 VDC. However, voltages greater than 170 VDC or less than 170 VDC are also contemplated as required for a given application.

The transformer 714 is configured to increase or decrease the AC voltage output from the inverter 713 to a level required to perform a welding operation. The high frequency rectifier 715 is configured to convert the AC power received from the transformer 714 into DC power that can be used to power the output of the welder 700. The configuration of the components of the welding circuit 710 are described in further detail in FIG. 7B below.

Returning to FIG. 7A, the battery pack 720 is configured to provide DC voltage to the booster circuit 730. In some embodiments, the battery pack 720 can be provided as single removable battery pack and may be similar to the battery pack(s) described above. In one specific example, the battery pack may have a nominal voltage of 72 VDC. In other embodiments, the battery pack 720 can be provided as multiple removable battery packs.

As described above, the booster circuit 730 is configured to provide DC voltage from the battery pack 720 to the inverter 713. In some embodiments, the booster circuit 730 is configured to include a DC-to-DC converter. For example, the DC-to-DC converter is a buck converter configured to receive an input voltage and provide a decreased voltage, while increasing current, to an output. In another example, the DC-to-DC converter is a boost converter configured to receive an input voltage and provide an increased voltage to an output. In yet another example, the DC-to-DC converter is buck-boost converter or any other suitable device to step-up and/or step-down DC power.

A battery pack controller 725 is integrated with the battery pack 720. The battery pack controller 725 is configured to control the battery pack 720 to supplement power provided to the welding circuit 710. The battery pack controller 725 is configured to communicate with the battery pack 720 and external components, such as the power controller 750. For example, the battery pack controller 725 may be configured to communicate a parameter, such as, temperature, state of charge, or the like, of the battery pack 720. In one embodiment, the battery pack controller 725 is configured to communicate with a power controller 750. In another example, the battery pack controller 725 is configured to generate an enable and/or disable signal to control power flow from the battery pack 720 to the booster circuit 730. For example, the battery pack controller 725 may receive a request from the power controller 750 to supplement power to the welding circuit 710. The request may include a defined amount of power to provide to the welding circuit 710. In another example, the battery pack controller 725 is configured to transmit parameters of the battery pack 720 to the power controller 750.

The welder also includes a sampling circuit 740, a triode for alternating current (TRIAC) control circuit 742, a drive circuit control module 744, a drive circuit 746, a current adjustment device 748, and a protection inspection device 752. The sampling circuit 740 is configured to sample an output of the welding circuit 710. For example, the sampling circuit 740 samples a voltage output from the welding circuit 710. However, in other examples, the sampling circuit 740 may sample a current, a power, a frequency, and/or other parameter of the output of the welding circuit 710 as required for a given application.

The TRIAC control circuit 742 provides switching control to the drive circuit module 744 based on the output of the sampling circuit 740. The drive circuit control module 744 is configured to provide a drive signal to the drive circuit control module 744. The drive circuit control module 744 is configured to regulate the inverter 713 to ensure the output is maintained at the desired level based on the data generated by the sampling circuit.

The current adjustment device 748 may be a user input that is configured to define an amount of current output by the welder 700. For example, the welder 700 may include a knob or other input device that allows a user to set the desired output current level via the current adjustment device 748. In some examples, the current adjustment device 748 may be integrated into, or controlled via, the wireless communication controller 455.

The protection inspection device 752 is configured to provide a fault indication to the power controller 750. For example, the fault indication can include a short in the power circuitry, an over-discharge condition of the battery pack 720, an overcurrent condition of the battery pack 720, and/or excessive heat generation of the battery pack 720.

The power controller 750 controls, via the drive circuit control module 744, an output of the inverter 713 as well as the power output from the battery pack 720 via the battery pack controller 725. The power controller 750 may further receive information from the battery pack controller 725 to allow for control of the inverter 713. The power controller 750 may be configured to operate the welder 700 in a hybrid mode. In the hybrid mode, the power controller 750 monitors an AC power provided by the AC source 701. The power controller 750 may then compare the AC power of the AC source 701 to an AC power threshold (described above) of the welder 700. The power controller 750 may be additionally configured to request power from the battery pack 720 in response the AC power of the AC source 701 exceeding the AC power threshold. The power controller 750 may also be configured to provide power from the battery pack 720 to power to the welding circuit 710 when the AC power of the AC source 701 is interrupted. The power controller 750 may be further configured to return to utilizing the AC source 701 to provide primary power to the welding circuit 710 when the AC source 701 is restored.

In some embodiments, the welder 700 is configured to use the AC power source 701 as a primary power source for powering the welding output. The welder 700 will use the AC power source 701 as the primary power source up to a predefined power threshold (e.g., a maximum power level than can be supplied by the AC power source 701). In response to the predefined power threshold being reached, the welder 700 will use supplemental power from the battery pack 720 to maintain the required output without the AC power source exceeding the predefined power threshold. In further embodiments, the welder 700 may use supplemental power from the battery pack 720 in the event that there is a loss of power from the AC power source.

Turning now to FIG. 7B, an example schematic configuration 800 of the welding circuit 710 of FIG. 7A is shown, according to some embodiments. The example configuration 800 includes a disconnect device 802, a bridge rectifier 804, a filter 806, an IGBT inverter 808, a transformer 810, and a secondary rectifier 812. The AC source 701 of FIG. 7A is connected to the disconnect device 802. The disconnect device 802 is configured to connect the AC source 701 to the bridge rectifier 804. For example, the disconnect device 802 may be a switch, a circuit breaker, or the like that configured to interrupt (e.g., shut off) a current flow from the AC source 701 to the welder output.

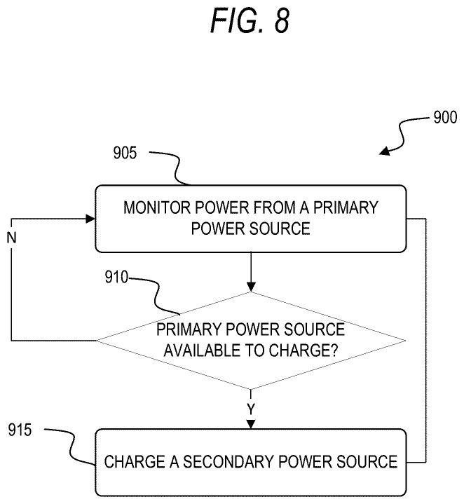

The bridge rectifier 804 is connected to the filter 806. In some embodiments, the bridge rectifier 804 may be similar to the rectifier 711 and the filter may be similar to the filter 712 described above with respect to FIG. 7. The bridge rectifier 804 may include four or more diodes in a bridge circuit configuration and configured to convert alternating (AC) current of the AC source 701 to a direct (DC) current voltage. The filter 806 may include one or more capacitors configured to reduce the AC ripple in the DC voltage output by the bridge rectifier 804. The filter 806 is connected to the IGBT inverter 808 and the booster circuit 730. The IGBT inverter may be similar to the inverter 713 described above with respect to FIG. 7. As described above, the booster circuit 730 may include a voltage regulator or other components configured to regulate/boost the output of the battery pack 720 to a DC voltage level input to the IGBT inverter 808 from the filters 806. The IGBT inverter 808 may include one or more insulated gate bipolar transistors and respective diodes. In some embodiments, the IGBT inverter 808 includes one or more MOSFETs (Metal-Oxide-Semiconductor Field-Effect Transistors). The IGBT inverter 808 is configured to for converting the adjusted DC voltage into AC voltage. The switching devices, such as IGBTs or MOSFETs are utilized to generate a high-frequency AC output. The IGBT inverter 808 provides the AC output to the transformer 810. In one embodiment, the transformer 810 is similar to the transformer 714 described above with respect to FIG. 7A. As shown in FIG. 8, the transformer 810 includes a primary winding and a secondary winding. The transformer 810 may also include a center-tap in the secondary winding. The transformer 810 is configured to change AC voltage level of the AC voltage output of the IGBT inverter 808 as required for a welding operation. Such transformers being termed step-up or step-down type to increase or decrease voltage level, respectively. The transformer 810 is connected to the secondary rectifier 812. The secondary rectifier 812 is a full wave rectifier configured to convert both half cycles of the AC output of the transformer 810 into pulsating DC output and may be similar to the high frequency rectifier 715 described above with respect to FIG. 7.

FIG. 8 illustrates a process 900 executed by the controller 400 of the hybrid welder 100. At process block 905, the controller 400 monitors power being provided by a primary power source. In some embodiments, the primary power source is an AC power source, such as provided via the AC power input circuit 471. At process block 910, the controller 400 determines whether the primary power source is available to charge a secondary power source, such as battery pack 474, based on the monitored power at process block 910. In one embodiment, the controller 400 determines that the primary power source is available to charge where the welder 100 is not currently in operation (e.g., welding). In other examples, the controller 400 may determine that the primary power source is available to charge where the output of the AC power input unit indicates that the AC power being used is below a predetermined charging threshold. In one example, the charging threshold may be 75% of maximum output. However, values of more than 75% or less than 75% are also contemplated as required for a given application.

In response to determining that the primary power source is available to charge the secondary power source, the controller 400 controls the primary power source to charge the secondary power source at process block 915. In one embodiment, the controller 400 may control charging of the secondary power source by routing power to the battery pack 474 via the DC power control unit 470. For example, the controller 400, via the DC power control unit 470 may be configured to control a charging operation to charge the battery pack 474 using an AC input power via the AC power input circuit 471. However, in some examples, one or more other components may be used to charge the secondary power source. The controller resumes monitoring power from the primary power source at process block 905.

In response to determining that the primary power source is not available to charge the secondary power source, the controller 400 resumes monitoring the primary power source at process block 905.

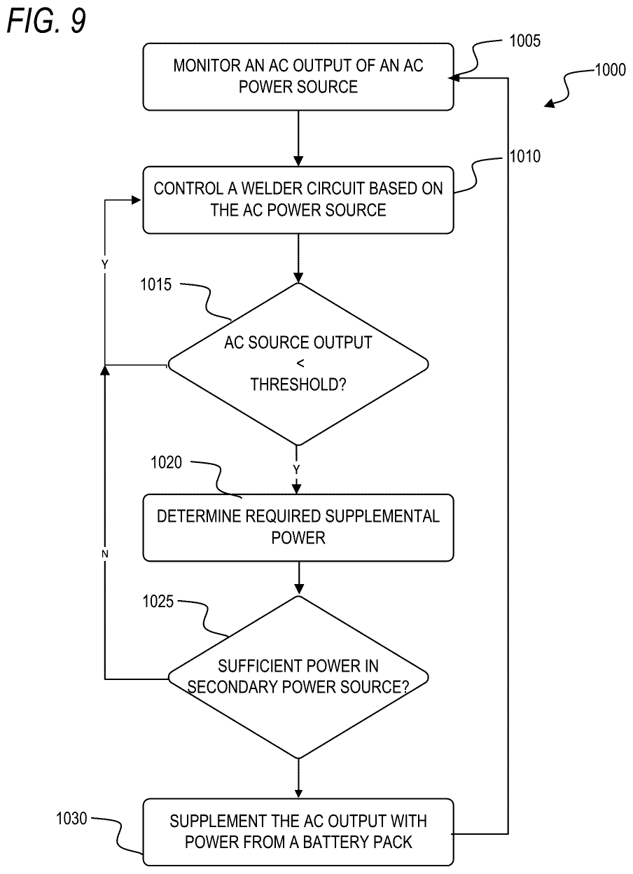

FIG. 9 illustrates a process 1000 executed by the controller 400 of the hybrid welder 100 for supplementing an AC power source (i.e., a primary power source) coupled to the welder 100 with a DC power source (i.e., a secondary power source), such as a battery pack. At process block 1005, the controller 400 monitors an output of an AC power source. In some embodiments, the controller 400 may monitor the AC power via one or more sensors 450 an input AC power from the AC power input circuit 471. In some examples, the welding circuit 465 may provide data associated with the AC output of the AC power source. However, other components described herein may also be configured to provide the controller with data regarding the AC output of the AC power source, as required for a given application.

At process block 1010, the controller 400 controls the welder 100 using only the AC power source. At process block 1015, the controller 400 determines whether the AC output is less than a maximum output threshold value. In one embodiment, the maximum output threshold value may be a value at the top range of the output that may be provided by the AC power source. As described above, the maximum output threshold value may be set by a user or may be determined by the controller 400 based on the available power of the AC power source. In one example, the maximum output threshold value may be 92% of a rating of the AC power source (e.g., a circuit breaker rating). However, threshold values of more than 92% or less than 92% are also contemplated.

In response to determining that the AC power source output is less than the maximum output threshold value, the controller 400 controls the welder, such as via the welding circuit 465, to only use the AC power source to perform a welding operation, such as via the AC power input circuit 471 at process block 1010. In response to determining that the AC power source is not less than the maximum output threshold value, the controller 400 determines the amount of required supplemental power to provide a full power output from the welding circuit at process block 1020. The required supplemental power may be based on a difference between the AC power source output and the maximum output threshold value. In other examples, the required supplemental power may be determined based on a difference between the maximum output threshold value and a power output requested by the welding circuit 465.

At process block 1025, the controller determines whether there is sufficient power in the DC power source, such as removable battery pack 474, to assist in the welding. In one example, the controller 400 determines that there is sufficient power in the DC power source where the power (e.g., SoC) in the DC power source is 25% or more of the rated power. However, values of more than 25% or less than 25% are also contemplated. Further, the controller 400 may look at various parameters of the DC power source (e.g., battery pack 474) to determine whether there is sufficient power, such as SoC, SoH, temperature, run time, and/or other parameters as required for a given application.

In response to determining that there is not sufficient power in the DC power source, the controller 400 powers the welder 100 using the AC power source only at process block 1010. In response to determining that there is sufficient power in the DC power source, the controller 400 controls the welding circuit 465 to power the welder output using both the AC power source and the DC power source to provide supplemental power at process block 1030. For example, the power controller 435 may be configured to provide power from the battery pack 474 to the welding circuit 465. As noted above, the output of the battery pack 474 may further be boosted (such as via boost circuit 730) to ensure that the provided voltage is sufficient to power the welding circuit 465. The controller 400 then continues monitoring the power from the primary power source at process block 1005.

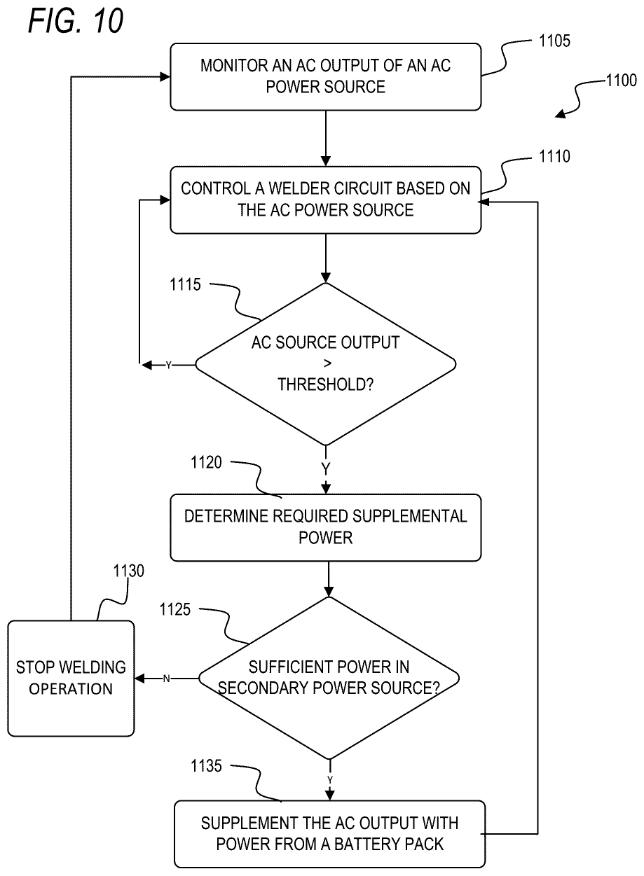

FIG. 10 illustrates a process 1100 executed by the controller 400 of the hybrid welder 100 for supplementing an AC power source (i.e., a primary power source) coupled to the welder 100 with a DC power source (i.e., a secondary power source), such as a battery pack in the event of a loss of the AC power source. At process block 1105, the controller 400 monitors an output of an AC power source. In some embodiments, the controller 400 may monitor the AC power via one or more sensors 450 an input AC power from the AC power input circuit 471. In some examples, the welding circuit 465 may provide data associated with the AC output of the AC power source. However, other components described herein may also be configured to provide the controller with data regarding the AC output of the AC power source, as required for a given application.

At process block 1110, the controller 400 controls the welder 100 using only the AC power source. At process block 1115, the controller 400 determines whether the AC output is less than a minimum output threshold value. In one embodiment, the minimum output threshold value may be a minimal voltage output provided by the AC power source that allows for welding operations. In one example, the minimum output threshold value may be 75% of a nominal AC voltage of the AC power source. In other examples, the minimum output threshold value may be more than 75% or less than 75% of the nominal AC voltage of the AC power source, as required for a given application.

In response to determining that the AC power source output is not less than the minimum output threshold value, the controller 400 controls the welder, such as via the welding circuit 465, to only use the AC power source to perform a welding operation, such as via the AC power input circuit 471 at process block 1110. In response to determining that the AC source is less than the minimum output threshold value, the controller 400 determines the amount of required supplemental power to provide sufficient power to the welding circuit to continue a welding operation at process block 1120. In some examples, such as where the AC power source is no longer providing power, the DC power source may need provide 100% of the required power. However, in other examples, the removable battery pack 474 may supply between 1% and 100% of the required power. The required supplemental power may be based on a difference between the AC power source output and the minimum output threshold value. In other examples, the required supplemental power may be determined based on a difference between the maximum output threshold value and a power output requested by the welding circuit 465.

At process block 1125, the controller determines whether there is sufficient power in the DC power source, such as removable battery pack 474, to assist in the welding operation. In one example, the controller 400 determines that there is sufficient power in the DC power source where the power (e.g., SoC) in the removable battery pack is 25% or more of the rated power of the removable battery pack. However, values of more than 25% or less than 25% are also contemplated. Further, the controller 400 may look at various parameters of the DC power source to determine whether there is sufficient power, such as SoC, SoH, temperature, run time, and/or other parameters as required for a given application.

In response to determining that there is not sufficient power in the DC power source, the controller 400 stops the welding operation at process block 1130. In response to determining that there is sufficient power in the DC power source, the controller 400 controls the welding circuit 465 to power the welder output using both the AC power source and the DC power source to provide supplemental power at process block 1135. For example, the power controller 435 may be configured to provide power from the DC power source to the welding circuit 465. As noted above, the output of the DC power source may further be boosted (such as via boost circuit 730) to ensure that the provided voltage is sufficient to power the welding circuit 465. The controller 400 then continues monitoring the power from the AC power source at process block 1105.

Thus, embodiments described herein provide, among other things, systems and methods for providing a welder that is capable of being powered simultaneously by both an AC power source and a DC power source.

What is claimed is:

1. A hybrid welder comprising:
a housing including a battery pack interface and an alternating current (“AC”) power input;
an alternating current (“AC”) power input configured to receive power from an AC power source and output an AC power output;
a battery pack interface configured to receive a removable battery pack;
a welding circuit configured to provide power to a welding electrode using the AC power input; and
an electronic controller, connected to the AC power source and the removable battery pack, wherein the electronic controller includes an electronic processor and a memory, the electronic controller configured to:
receive power from the AC power source,
determine whether the power from the AC power source exceeds a maximum power output threshold, and
supplement the power provided to the welding circuit with power from the removable battery pack in response to the power exceeding the maximum output threshold.

2. The hybrid welder of claim 1, wherein the maximum power output threshold is 92% of a full rated output of the AC power source.

3. The hybrid welder of claim 1, wherein the controller is further configured to determine whether the removable battery pack has sufficient power to provide the supplemental power to the welding circuit.

4. The hybrid welder of claim 3, wherein the removable battery pack is determined to have sufficient power where a state-of-charge of the removable battery pack is at least 50% of a full state-of-charge.

5. The hybrid welder of claim 1, wherein the removable battery pack has a nominal voltage of 72 VDC.

6. The hybrid welder of claim 1, wherein the removable battery pack is a fan-cooled removable battery pack.

7. The hybrid welder of claim 1, further comprising a booster circuit coupled between the battery pack interface and the welding circuit and configured to boost an output voltage of the removable battery pack to a voltage required by the welding circuit.

8. The hybrid welding of claim 7, wherein the voltage required by the welding circuit is approximately 170 VDC.

9. A method of powering a hybrid welding device, comprising:
receiving an alternating current (“AC”) power from an AC power source an at a welding circuit;
determining, at an electronic processor of the hybrid welding device, whether the AC power from the AC power source exceeds a maximum power output threshold, and
supplementing the power provided to the welding circuit with power from a removable battery pack coupled to the welding circuit in response to the power exceeding the maximum output threshold.

10. The method of claim 9, further comprising:
detecting a loss of AC power at the welding circuit by the electronic processor; and
supplementing the power provided to the welding circuit with power from a removable battery pack coupled to the welding circuit in response to detecting the loss of AC power.

11. The method of claim 9, wherein the maximum power output threshold is 92% of a full rated output of the AC power source.

12. The method of claim 9, further comprising:
determining, by the electronic processor, whether the removable battery pack has sufficient power to provide the supplemental power to the welding circuit; and
supplementing the power provided to the welding circuit with power from a removable battery pack coupled to the welding circuit in response to the power exceeding the maximum output threshold and determining that the removable battery pack has sufficient power to provide the supplemental power to the welding circuit.

13. The method of claim 12, wherein the removable battery pack is determined to have sufficient power where a state-of-charge of the battery removable battery pack is at least 25% of a full state-of-charge.

14. The method of claim 9, wherein the removable battery pack is a fan cooled removable battery pack with a nominal output voltage of 72 VDC.

15. The method of claim 9, further comprising boosting an output voltage of the removable battery pack to a voltage required by the welding circuit using a booster circuit coupled between the removable battery pack and the welding circuit.

16. A hybrid welder comprising:
a housing including a battery pack interface and an alternating current (“AC”) power input;
an alternating current (“AC”) power input configured to receive power from an AC power source and output an AC power output;
a battery pack interface configured to receive a removable battery pack;
a welding circuit configured to provide power to a welding electrode using the AC power input;
a power control circuit configured to charge the removable battery pack using the received AC power; and
an electronic controller, connected to the AC power source and the removable battery pack, wherein the electronic controller includes an electronic processor and a memory, the electronic controller configured to:
receive power from the AC power source,
determine whether the power from the AC power source exceeds a maximum power output threshold,
determine whether the removable battery pack has sufficient power to provide a supplemental power to the welding circuit; and
supplement the power provided to the welding circuit with power from the removable battery pack in response to the power exceeding the maximum output threshold and the removable battery pack being determined to have sufficient power to provide the supplemental power to the welding circuit.

17. The hybrid welder of claim 16, wherein the maximum power output threshold is 92% of a full rated output of the AC power source.

18. The hybrid welder of claim 16, wherein the removable battery pack is determined to have sufficient power where a state-of-charge of the removable battery pack is at least 25% of a full state-of-charge.

19. The hybrid welder of claim 16, further comprising a booster circuit coupled between the battery pack interface and the welding circuit and configured to boost an output voltage of the removable battery pack to a voltage required by the welding circuit.

20. The hybrid welding of claim 19, wherein the voltage required by the welding circuit is approximately 170 VDC.
